(19) United States
(12) Patent Application Publication
(10) Pub. No.: US 2010/0224746 A1
(43) Pub. Date: Sep. 9, 2010

(54) Durable Ice Auger Mounting System that Maximizes Mobility and Support for Auger Device

(76) Inventors: Clint Johnson, Dousman, WI (US); Steve Gapp, Dousman, WI (US); John Reed Felton, Wauwatosa, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/715,239

(22) Filed: Mar. 1, 2010

Related U.S. Application Data
(60) Provisional application No. 61/157,479, filed on Mar. 4, 2009.

(51) Int. Cl. F16M 13/00

(52) U.S. Cl. 248/205.1; 248/299.1; 248/289.11; 248/288.31

(57) ABSTRACT

The present invention is an auger transport and mounting system which facilitates the drilling and positioning of ice fishing or other holes in an outdoor surface.

### CROSS-REFERENCE TO RELATED APPLICATIONS

This application claims priority to U.S. Provisional Application No. 61/157,479 filed on Mar. 4, 2009.

### FIELD OF INVENTION

The present invention relates generally to augers and more specifically to auger mounting assemblies for use with any motor vehicle, and which further includes features to support and stabilize an auger when it is in use.

### BRIEF DESCRIPTION OF THE DRAWINGS

FIG. 1 illustrates a side view of an exemplary embodiment of an auger mounting system mounted on an all-terrain vehicle (ATV).

FIG. 2 illustrates a perspective view of an exemplary embodiment of mounting plates for an auger mounting system.

FIG. 3 illustrates a perspective view of an exemplary embodiment of an auger collar for an auger mounting system.

FIG. 4 illustrates a side view of an exemplary embodiment of a hinged arm component for an auger mounting system.

FIG. 5a illustrates a side view of an exemplary embodiment of a quick release clamp for an auger mounting system in an open position.

FIG. 5b illustrates a side view of an exemplary embodiment of a quick release clamp for an auger mounting system in a closed position.

FIG. 6a illustrates a perspective view of a first exemplary embodiment of an auger attachment plate for an auger mounting system.

FIG. 6b illustrates a perspective view of a second exemplary embodiment of an auger attachment plate for an auger mounting system.

FIG. 7 illustrates a side view of a second exemplary embodiment of an auger mount system with auger attachment plate mounted on an ATV.

FIG. 8 illustrates a side view of an exemplary embodiment of an auger mounting system mounted on a snowmobile.

FIG. 9a illustrates a perspective view of an exemplary embodiment of a frame component of an auger mounting system for use with a snowmobile.

FIG. 9b illustrates a perspective view of another exemplary embodiment of a frame component of an auger mounting system for use with a snowmobile.

FIG. 9c illustrates a perspective view of the exemplary embodiment of the frame component shown in FIG. 9b positioned at an angle.

FIG. 10 illustrates a top view of an exemplary embodiment of an auger mounting system mounted to a truck.

### GLOSSARY

As used herein, the term “arm” is a component which is used to manipulate and position an auger. An arm may be pivotal, telescoping, hinged, fixed, spring-loaded, a lever or include any other component which may be manipulated to position an auger.

As used herein, the term “attachment member” refers to a component of an auger mounting system that securely and fixedly attaches an auger to the arm of an auger mounting system. An attachment member may be a collar, clamp, lever, plate, welded component, or combinations thereof.

As used herein, the term “auger” refers to a device having a rotating helical shaft used for moving material or liquid. For example, an ice auger is used to cut a circular or larger rectangular hole in the ice for ice fishing.

As used herein, the term “auger attachment plate” refers to an attachment member that is secured directly to the handle plate of an auger.

As used herein, the term “auger collar” refers to an attachment member that supports an auger. In various embodiments, an auger collar may encircle a shaft.

As used herein, the term “auger shaft” refers to a cylindrical component of an auger.

As used herein, the term “ball joint” refers to a spherical bearing that allows for rotational movement along multiple axes.

As used herein, the term “frame component” refers to a compent for securing an auger mount system to a snowmobile.

As used herein, the term “holster” refers to a component of an auger mounting system that holds, supports or stabilizes an auger when the auger is not in use.

As used herein, the term “mounting plate” refers to a component used to secure an auger mounting system to a vehicle or vehicle rack.

As used herein, the term “quick release clamp” refers to an attachment member that allows an auger to be removed from the auger mounting system.

As used herein, the term ° quick release component” refers to a component which is mechanically manipulated via a lever, button, or pin to release another component.

As used herein, the term “securing component” refers to a component that secures the auger inside a holster when not in use.

### Background

Augers are used on frozen lakes, ponds, etc., for drilling holes in the ice for ice fishing, as well as on land for drilling holes for fence posts, for example. In the recent past, hand-held, power driven augers have been used in these applications. However, because of their shape and weight, hand-held, power driven augers are bulky to transport and can be difficult to use. A typical hand-held, power driven auger weighs between forty and seventy pounds. Additionally, the vibration of the auger can cause fatigue when supporting the auger during drilling, and transporting.

Typically, an ice fishing participant drills several holes at different locations on the ice. This requires relocating the auger for each hole drilled. For this reason, devices have been developed to make it easier to mount and remove an auger and to support the weight of an auger.

There are many difficulties known in the prior art with respect to existing auger mounting systems for mounting an auger on a vehicle. Both metal and plastic parts are known to malfunction in cold temperatures and the vehicle may shift from its original postion on icy surfaces or from the motion of the auger. For example, U.S. Pat. No. 6,681,470 (Scott '470) discloses an auger mounting system whereby an auger is easily transported and used while attached to a vehicle, and which allows an auger to be positioned along a vertical axis, and rotated to a horizontal position for transport.

Scott '470 provides support for an auger and faciltates transport of the auger; however, the range of motion of the device is limited to a vertical axis. The limitation to a vertical axis means that the vehicle must be moved each time a new hole is drilled. Furthermore, if the vehicle shifts in postion on a slippery surface, the auger cannot be easily adjusted or repositioned to promptly compensate for the shift of the vehicle.

Additonally, the auger mounting system taught by Scott '470 requires a user to go through the extra step of moving the auger from a horizontal to vertical postion during transport from drilling location to drilling location.

Additionally, all-terrain vehicles (ATV), and even snowmobiles if the auger is to be used to drill holes in ice, may be used to transport an auger to a point of use. Because of their size, maneuverability, four-wheel drive capability, and relatively low weight, ATVs are particularly well-suited for transporting augers to fence lines, along trails as well as for driving on frozen lakes.

Auger mounting systems for ATVs, such as that the system disclosed by Scott '470 and by U.S. Pat. No. 5,836,402 (Jones '402), which discloses an auger holder for mounting an auger on a vehicle such as an ATV, transporting the auger to a point of use, and enabling the auger to be operated while attached to the vehicle, are known in the art. However, the design of these auger mounting systems interferes with the functionality of the vehicle. The auger mounting system taught by Jones '402 mounts on the top of the ATV's cargo rack and connects to the hitch mount. As a result, the ATV cannot haul cargo or pull a trailer without first removing the auger and the auger holder from the vehicle. The auger mounting system taught by Scott ‘470 requires cumbersome sliding plates to be fixedly attached to the ATV adding bulk.

It is desirable to have an auger mounting system which allows an extensive range of horizontal, as well as vertical, movement in supporting an auger.

It is further desirable to have an auger mounting system which does not require the auger to be repositioned from a horizontal postion to a vertical position prior to use.

It is further desirable to have an auger mounting system that offers quick release capability, and includes a support mechanism and assembly that reduces the effort required to reposition the auger.

It is further desirable to have an auger mounting system that allows an auger to be easily manipulated and quickly repositioned.

### Summary of the Invention

The present invention is an auger transport and mounting system comprised of a pivotal arm which can be rotated and moved horizontally and vertically, an attachment plate which attaches an auger to the auger mounting system, a holster assembly for supporting the auger when not in use, and a securing component for securing the auger inside the holster assembly.

### Detailed Description of Invention

For the purpose of promoting an understanding of the present invention, references are made in the text to exemplary embodiments of an ice auger mounting system, only some of which are described herein. It should be understood that no limitations on the scope of the invention are intended by describing these exemplary embodiments. One of ordinary skill in the art will readily appreciate that alternate but functionally equivalent materials, components and designs may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

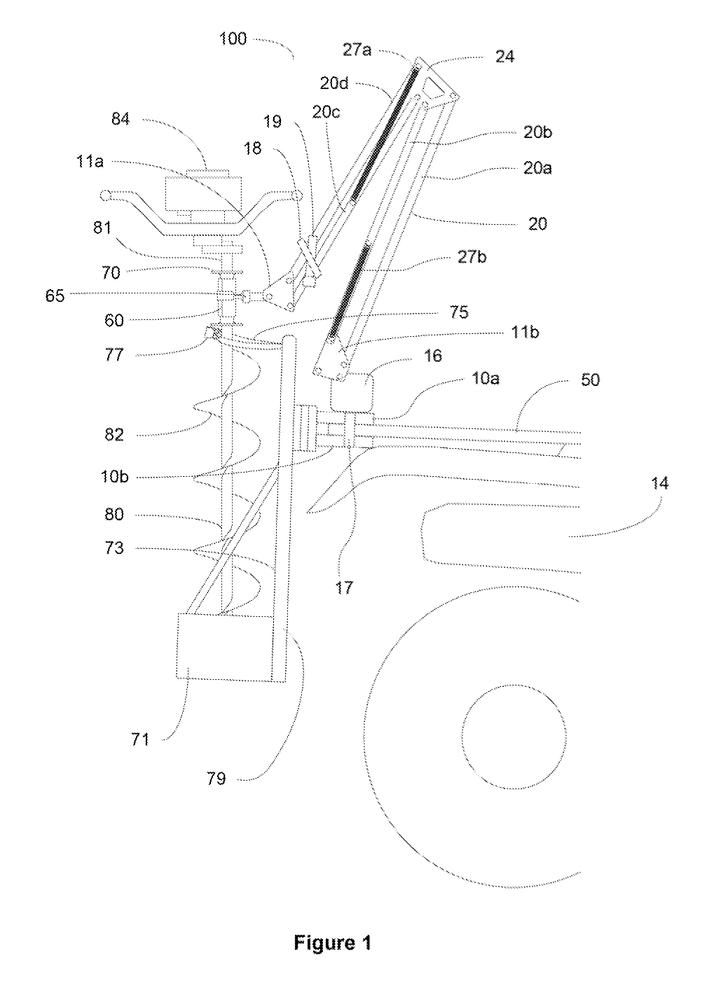

FIG. 1 illustrates a side view of an exemplary embodiment of auger mounting system 100 mounted on any vehicle or all-terrain vehicle (ATV) 14. In the embodiment shown, auger mounting system 100 secures auger 80 to ATV 14 and enables auger 80 to be oriented in an upright, generally vertical position during use, when not in use and during transport. In other embodiments, auger mounting system 100 may be used to secure auger 80 to a snowmobile or another type of utility vehicle (e.g., MULE™), automobile, truck or any other type of vehicle capable of being driven on ice.

In the embodiment shown, holster assembly 79 is comprised of holster base 71, holster frame 73, and securing component comprised of holster yoke 75, and securing device 77. Holster yoke 75 is attached to holster frame 73 and is secured around auger shaft 81 with securing device 77 securing auger 80 to holster assembly 79 and inside holster base 71 when not in use. In the embodiment shown, holster yoke 75 is a strap and securing device 77 is a clasp, but in other embodiments may be a bungee cord, chain, wire, metal clamp, metal ring, U-clamp, padlock, rope, or other securing device(s) known in the art.

In the embodiment shown, holster assembly 79 is secured to ATV rack 50 using mounting plates 10a, 10b. In other embodiments, holster assembly 79 may be secured to ATV rack 50 using only one mounting plate 10a and a bolt, such as a U-bolt, curved bolt, or by a functionally equivalent structure assembled from one or more parts.

Also visible in FIG. 1 is pivotal arm 20. In the embodiment shown, pivotal arm 20 is comprised of tubing components 20a, 20b, 20c, 20d. Tubing components 20a, 20b, 20c, 20d are rectangular and constructed of metal and are generally rigid, rust-resistant and are adapted for use in cold temperatures. In other embodiments, tubing components 20a, 20b, 20c, 20d may be hollow, solid, round, triangular, square or any other shape and may be made of a material other than metal, such as plastic, fiberglass or composites that is rigid and durable enough to support the weight of an auger and is adapted for use in cold weather.

In the embodiment shown, pivotal arm 20 is comprised of four tubing components; however, in other embodiments, pivotal arm 20 may be comprised of any number of tubing components.

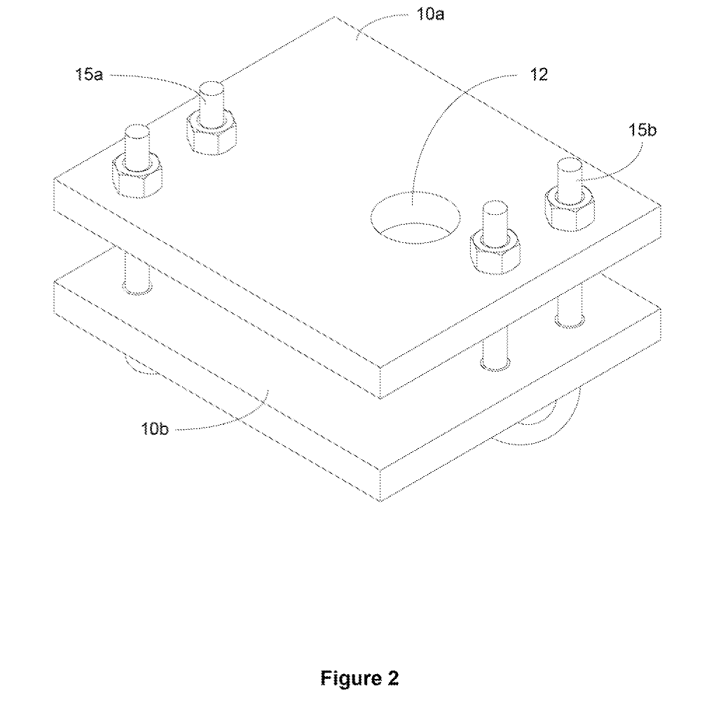

Attached or configured at the base of pivotal arm 20 is pivot member 16 with arm rod 17 which fits into plate aperture 12 (FIG. 2) in mounting plates 10a, 10b secures pivotal arm 20 to mounting plates 10a, 10b. Pivot member 16 is secured to hinged arm mount plate 11b using a bolt, pin or another fastening member. In the embodiment shown, pivot member 16 and pivot assembly 24 allow pivotal arm 20 to move forward or backward, left or right and/or vertically simultaneously. In other embodiments, pivotal arm 20 may use a combination of pivot points, telescoping tubes, linear bearings, fluid couplings, hydraulic or air assist, springs, rope or cable suspension systems, magnetic attraction/repellent devices, or similar assemblies to pivot and rotate.

Arm rod 17 has aperture 30 (FIG. 4) located near the end of arm rod 17 furthest from pivotal arm 20. A securing device, such as a clip, bolt, split pin, hairpin cotter pin, bowtie cotter pin, circle cotter or detent, is inserted through aperture 30 securing mounting plates 10a, 10b to ATV rack 50.

Pivotal arm 20 further includes pivot assembly 24 and hinged arm mount plates 11a, 11b. Pivot assembly 24 and hinged arm mount plates 11a, 11b contain rods, pins or another linkage or hinge component known in the art.

In the embodiment shown, pivotal arm 20 furthers includes optional springs 27a, 27b which help to neutralize and counterbalance the weight of auger 80 while in the user's hands and assist the user in applying the force required for drilling and positioning of auger 80. In other embodiments, counterweights, pressurized gas cylinders, electromechanical actuated devices, elastic bands, magnetic forces, similar mechanical or electrical devices or combinations thereof may be used in place of, or in addition to springs 27a, 27b to adjust the effective weight of auger 80 during use.

In the embodiment shown, pivotal arm 20 can rotate up to 360 degrees and can be used to move auger 80 horizontally and vertically and/or to position auger 80 at any angle relative to ATV 14 or other vehicle or to the surface of the ice. Springs 27a, 27b, in combination with pivotal arm 20, allow auger 80 to be rapidly repositioned over the ice when in use. In addition, the combination of pivotal arm 20, pivot assembly 24 and ball joint 65 allow for effective movement and positioning of the auger and allow the auger to be placed in a vertical or near-vertical position for drilling even when the surface is unlevel.

In the embodiment shown, auger mounting system 100 further includes auger collar 70 and quick release clamp 60. Auger collar 70 encircles auger shaft 81 of auger 80 between auger blade 82 and auger motor 84 and connects to hinged arm mount plate 11a of pivotal arm 20 securing auger 80 to auger mounting system 100 and stabilizing auger 80. Quick release clamp 60 encircles auger collar 70 and allows auger 80 to be removed from auger mounting system 100 without removing auger collar 70.

Auger mounting system 100 may further include optional flashlight clamp 18 for securing flashlight 19 for viewing auger 80 during operation. In the embodiment shown, flashlight clamp 18 is a clamp secured to tubing components 20c, 20d, but in other embodiments may be secured to another location of auger mounting system 100. For example, flashlight clamp 18 may be secured to auger base 71, holster frame 73, holster yoke 75 or securing device 77. In other embodiments, flashlight 19 may be secured to auger mounting system 100 using another method, such as by a retractable line.

FIG. 2 illustrates a perspective view of an exemplary embodiment of mounting plates 10a, 10b for auger mounting system 100. In the embodiment shown, attachment plates 15a, 15b connect and secure plates 10a, 10b together when secured to ATV rack 50. In the embodiment shown, attachment plates 15a, 15b are U-bolts, but in other embodiments may be standard bolts, another bolting device or securing mechanism known in the art. In still other embodiments, mounting plates are a single component or are permanently attached together by a means known in the art (e.g., welding).

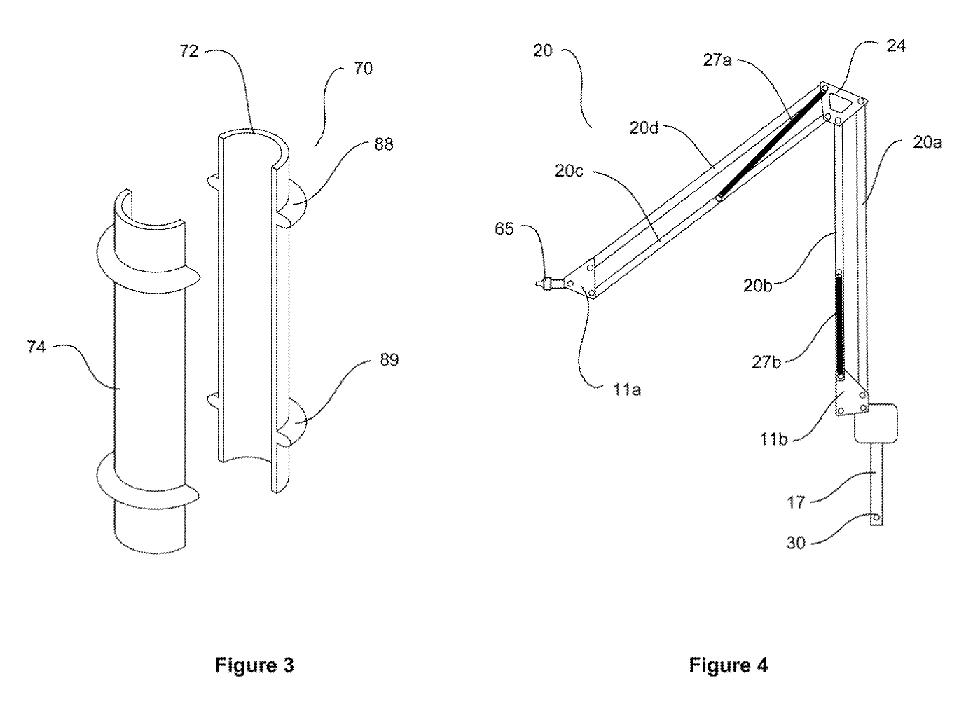

FIG. 3 illustrates a perspective view of an exemplary embodiment of auger collar 70 for auger mounting system 100. In the embodiment shown, auger collar 70 is comprised of semi-cylindrical components 72, 74 that fit around auger shaft 81 and further includes protuberances 88, 89 which prevent quick release clamp 60 (not shown) from sliding off auger collar 70. Semi-cylindrical components 72, 74 may be fitted together with ridged or hinged components. In other embodiments, semi-cylindrical components 72, 74 may be secured together around auger shaft 81 using screws, bolts, clamps, pins or another securing device or auger collar 70 may be molded as a single piece.

In the embodiment shown, auger collar 70 has a height of six inches and is comprised of metal. In other embodiments, auger collar 70 may have a height of one to eight inches and may be comprised of plastic, fiberglass or another temperature resistance material.

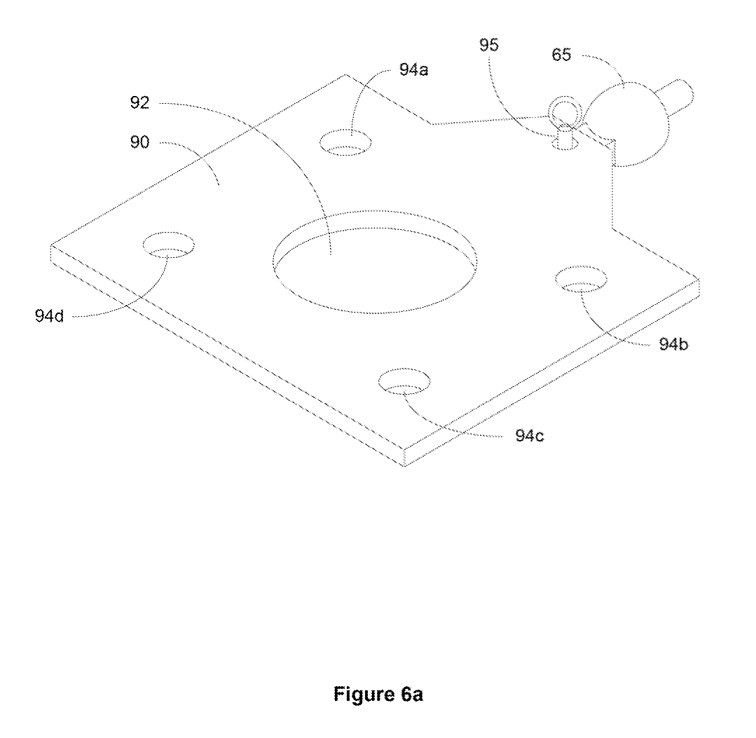

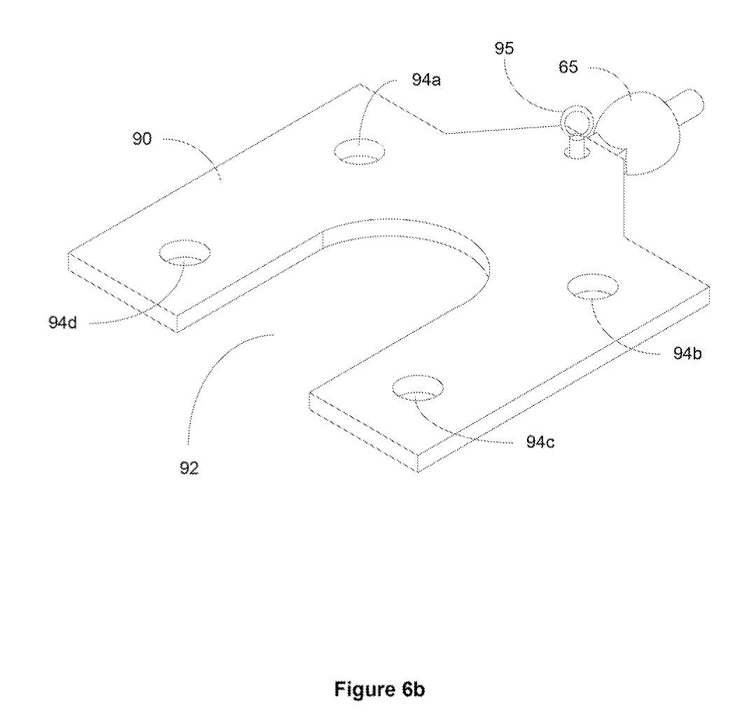

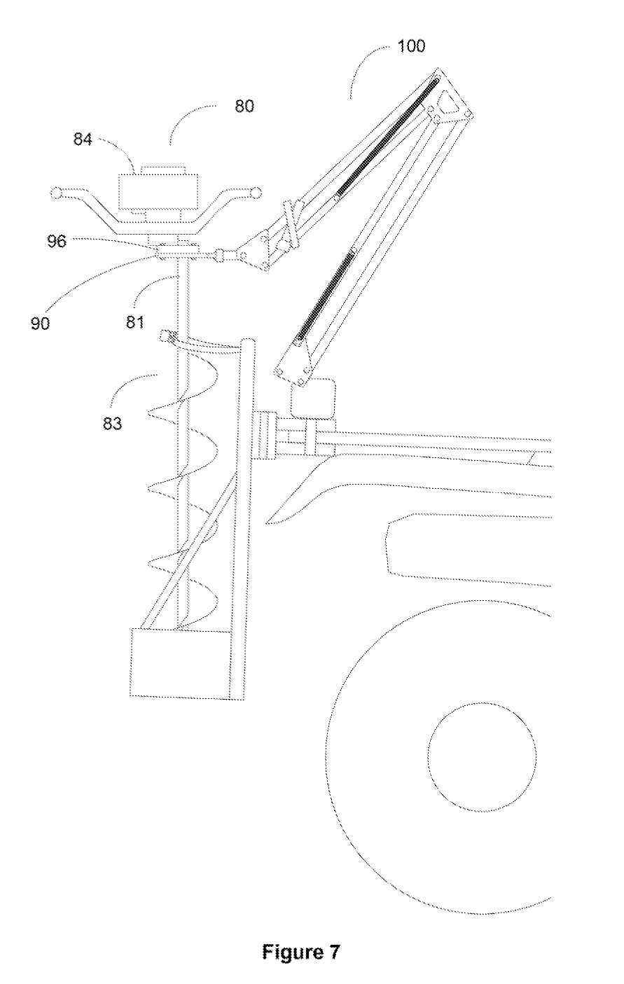

In other embodiments, auger collar 70 and quick release clamp 60 are replaced with a single component that can be secured to auger shaft 81. For example, an auger attachment plate (FIGS. 6a, 6b and 7) may be used to secure auger mounting system 100 to auger 80.

FIG. 4 illustrates a side view of an exemplary embodiment of hinged arm component 20 comprised of tubing components 20a, 20b, 20c, 20d, hinged arm mount plates 11a, 11b, pivot assembly 24, arm rod 17 and springs 27a, 27b. In the embodiment shown, hinged arm component 20 further includes optional ball joint 65 which allows ice auger to be rotated in any direction to level auger 80 and to allow for vertical drilling of a hole without resistance from hinged arm component 20.

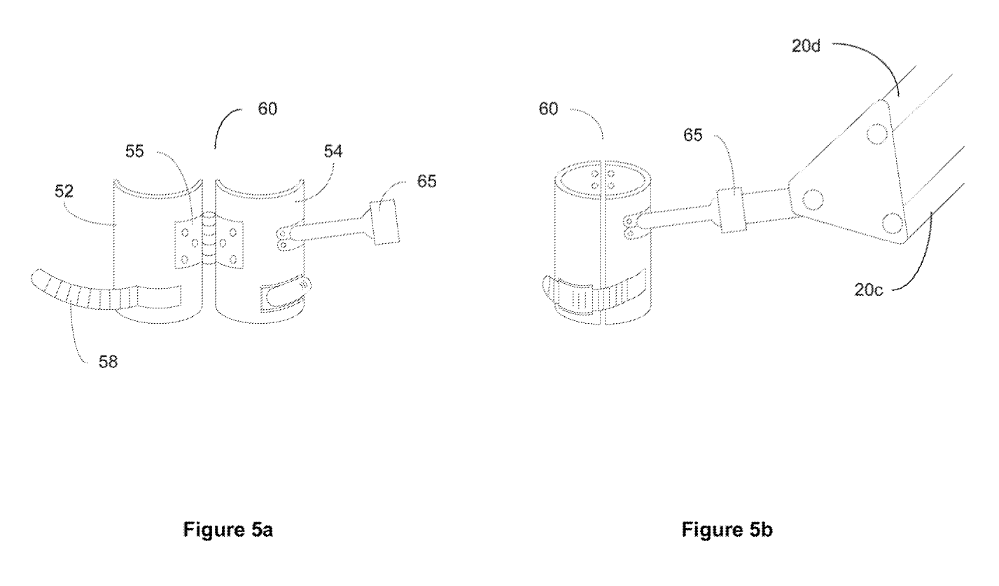

FIG. 5a illustrates a side view of an exemplary embodiment of quick release clamp 60 in an open position. In the embodiment shown, quick release clamp 60 is comprised of semi-cylindrical components 52, 54 which are secured together on one side by hinge 55. Quick release clamp 60 is placed around auger shaft 81 between auger blade 82 and auger motor 84 and tightened around auger shaft 81 using fastening component 58. In the embodiment shown, fastening component 58 is a strap and buckle. In other embodiments, fastening component 58 may be clamps, ties, or another fastening mechanism known in the art.

In the embodiment shown, quick release clamp 60 further includes optional ball joint 65 which is secured to quick release clamp 65 (e.g., by welding or bolting) and allows quick release clamp 60 to rotate so that auger 80 can be positioned vertically, horizontally and at any angle.

FIG. 5b illustrates a side view of an exemplary embodiment of quick release clamp 60 in a closed position. Also visible are optional ball joint 65 and tubing components 20c, 20d of pivotal arm 20.

FIG. 6a illustrates a perspective view of a first exemplary embodiment of auger attachment plate 90 for auger mounting system 100. Auger attachment plate 90 may be used in place of auger collar 70 and quick release clamp 60 to secure auger mounting system 100 to auger 80. In the embodiment shown, auger attachment plate 90 has auger shaft opening 92, bolt apertures 94a, 94b, 94c, 94d, quick release component 95 and ball joint 65.

Quick release component 95 allows auger 80 to be quickly removed from auger mount system 100. In the embodiment shown, quick release component 95 is a pin; however, in embodiments, may be a cam lever, clevis, hinge, slot, keyway, threaded or grooved components, or combinations thereof. In the embodiment shown, auger shaft opening 92 is circular.

In the embodiment shown, bolt apertures 94a, 94b, 94c, 94d correspond to the locations of the bolts on the bottom of a handle plate of a Jiffy Power Ice Drill®. In other embodiments, the location of the bolts corresponds to another type of ice auger (e.g., StrikeMaster® Ice Auger).

FIG. 6b illustrates a perspective view of a second exemplary embodiment of auger attachment plate 90 for auger mounting system 100. In the embodiment shown, auger attachment plate 90 has auger shaft opening 92, bolt apertures 94a, 94b, 94c, 94d, quick release component 95, and ball joint 65. In the embodiment shown, auger shaft opening 92 is U-shaped, which allow auger attachment plate 90 to be secured to auger 80 without having to remove the drill assembly from the auger motor.

FIG. 7 illustrates an exemplary embodiment of auger mounting system 100 secured to auger 80 using auger attachment plate 90. To secure auger attachment plate 90 to auger 80, drill assembly 83 (i.e., shaft and blade portion of auger) is removed from auger motor 84 and the bolts are removed from the top of handle plate 96. Auger attachment plate 90 is then placed on the bottom of handle plate 96 so that auger shaft aperture 92 lines up with the location of auger shaft 81 and bolt apertures 94a, 94b, 94c, 94d (not shown) line up with the locations of the bolt apertures on the bottom of handle plate 96. The removed bolts are then replaced and drill assembly 83 is reattached to auger motor 84.

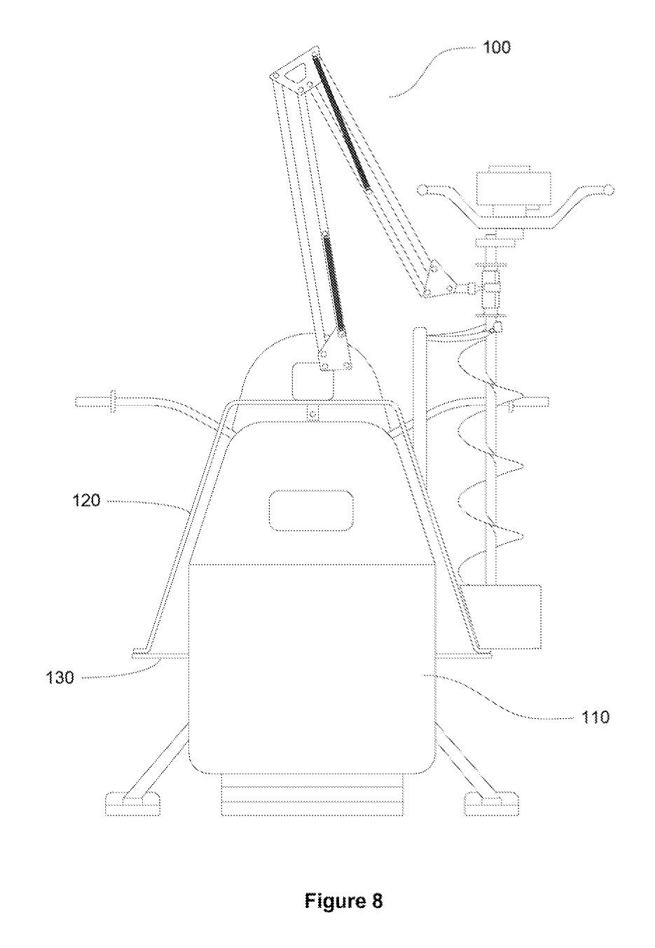

FIG. 8 illustrates a side view of an exemplary embodiment of auger mounting system 100 mounted on snowmobile 110. Frame component 120 fits over snowmobile 110 and is mounted to the rear of snowmobile floorboard 130 using bolts, clamps, screws, by welding, or by another means known in the art.

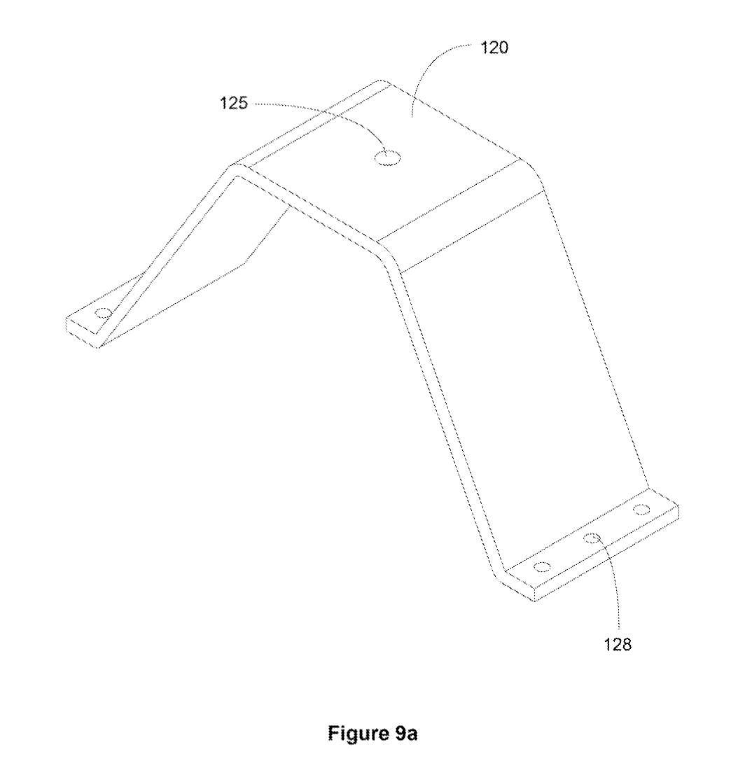

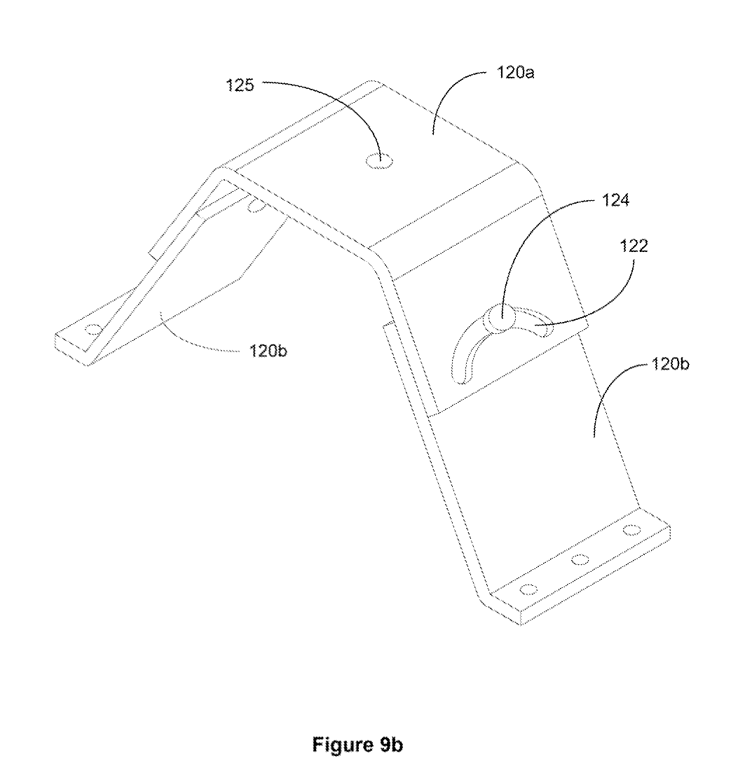

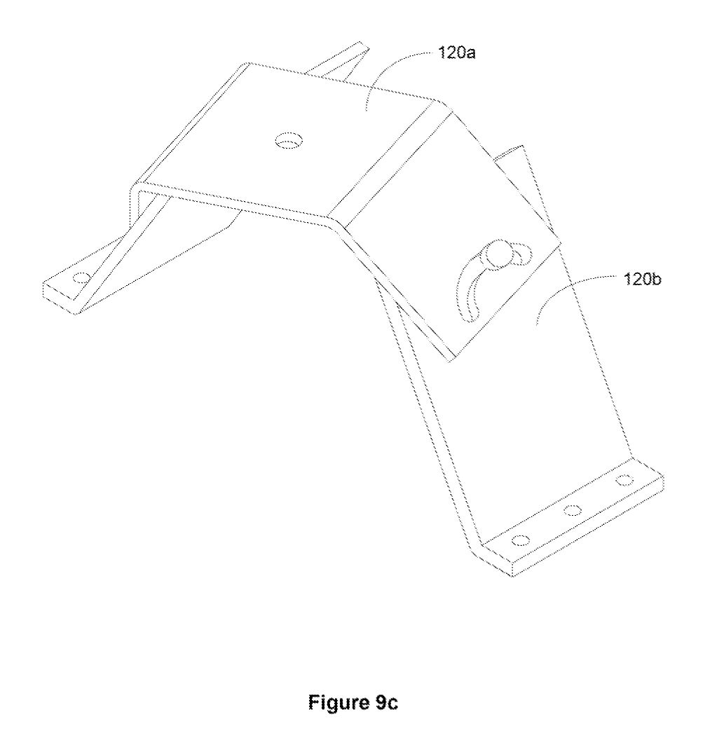

FIG. 9a illustrates a perspective view of an exemplary embodiment of frame component 120 of auger mounting system 100. Frame component 120 has aperture 125 for securing arm rod 17 of auger mounting. system 100 and bolt apertures 128 for securing frame component 120 to snowmobile floorboard 130 (not shown). In the embodiment shown, frame component 120 is comprised of a single component.

In the embodiment shown, each side of frame component 120 has three bolt apertures 128; however, in other embodiments, frame component 120 may include fewer or more apertures. In various other embodiments, frame component 120 may be secured to snowmobile floorboard 130 by clamps, welding, or any means known in the art.

FIG. 9b illustrates a perspective view of another exemplary embodiment of frame component 120. In the embodiment shown, frame component 120 is comprised of two components 120a, 120b. Frame component 120a has aperture 125 for securing arm rod 17 and channels 122 (one on each side). Frame components 120a, 120b are secured together using fasteners 124 (one per channel). Fasteners 124 remain stationary while frame component 124a moves by changing the location of fasteners 124 in channels 122. Frame component 120a rotates in relation to frame component 120b allowing ice auger 80 (not shown) to be rotated for vertical drilling. Once ice auger 80 (not shown) is in the desired position, fasteners 124 are tightened securing frame components 120a, 120b and locking auger into position.

In the embodiment shown, fasteners 124 are hand-turned knobs, but in other embodiments may be a component which is tightened using a tool (e.g., a wrench) and/or may include an additional component, such as a nut.

FIG. 9c illustrates a perspective view of frame component 120 shown in FIG. 9b positioned at an angle.

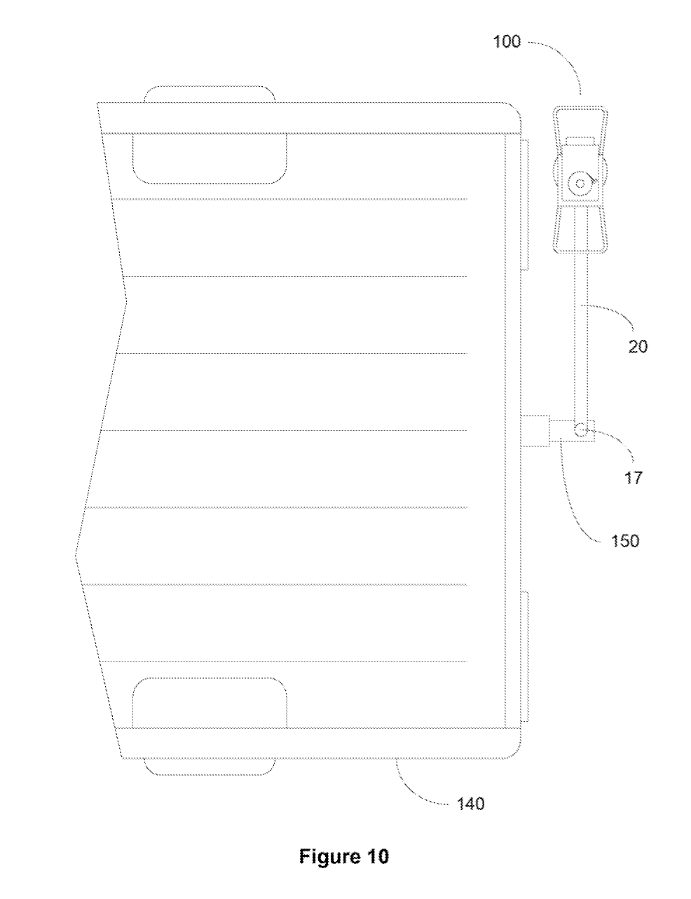

FIG. 10 illustrates a top view of an exemplary embodiment of auger mounting system 100 mounted to truck 140. Arm rod 17 of auger mounting system 100 is placed through aperture in mount insert 150. Arm rod 17 is secured to mount insert 150 by placing a securing device, such as clip, bolt, split pin, hairpin cotter pin, bowtie cotter pin, circle cotter or detent, through aperture 30 (not shown) located near the end of arm rod 17 furthest from pivotal arm 20.

What is claimed is:

1. An auger mounting apparatus comprised of:
a arm which can be rotated and moved along at least two axes;
an attachment member which attaches an auger to said arm;
a holster assembly for supporting said auger when not in use; and
a securing component for securing said auger inside said holster assembly.

2. The apparatus of claim 1 where is said arm is pivotal.

3. The apparatus of claim 1 wherein said axes are vertical and horizontal.

4. The apparatus of claim 1 wherein said auger may be moved on four axes.

5. The apparatus of claim 1 wherein said arm is a pivotal arm comprised of a plurality of tubing components.

6. The apparatus of claim 1 wherein said arm further includes at least one component to facilitate use of said auger selected from a group consisting of springs, counterweights, pressurized gas cylinders, electromechanical actuated devices, elastic bands, magnetic forces, and combinations thereof.

7. The apparatus of claim 1 wherein said arm further includes a pivot assembly.

8. The apparatus of claim 1 wherein said attachment member is an auger collar.

9. The apparatus of claim 1 wherein said attachment member is a quick release clamp.

10. The apparatus of claim 1 wherein said attachment member is an auger attachment plate.

11. The apparatus of claim 1 wherein said auger attachment plate further includes a quick release component.

12. The apparatus of claim 1 which further includes a frame component.

13. The apparatus of claim 1 which further includes a plurality of mounting plates.

14. The apparatus of claim 1 which further includes at least one ball joint.

15. The apparatus of claim 1 wherein said holster assembly is comprised of a holster base, a holster frame and a securing component.

16. The apparatus of claim 1 when said holster assembly is comprised of holster yoke and securing device.

17. The apparatus of claim 16 wherein said holster yoke is attached to a holster frame and is secured around said auger shaft with a holster securing device.

18. The apparatus of claim 16 wherein said holster yoke is a strap.

19. The apparatus of claim 17 wherein said holster securing device is selected from a group consisting of a clasp, bungee cord, chain, wire, metal clamp, metal ring, U-clamp, padlock, and rope.

20. An auger mounting system comprised of:
a vehicle adapted to receive a mounting component;
an arm which can be rotated and moved along at least two axes;
an attachment member which attaches an auger to said arm;
a holster assembly for holding said auger when not in use; and
a securing component for securing said auger inside said holster assembly.
